(19) United States
(12) Patent Application Publication
(10) Pub. No.: US 2026/0348164 A1
(43) Pub. Date: Nov. 5, 2026

(54) TERRACE CANOPY

(71) Applicant: RENSON OUTDOOR NV, Kruisem (BE)

(72) Inventors: Floris Albert BONTINCK, Heusden (Destelbergen) (BE); Thomas DE RYCKE, Gent (BE); Joost Renaat Benjamin DE FRENE, Waregem (BE)

(21) Appl. No.: 19/116,464

(22) PCT Filed: Sep. 28, 2023
(86) PCT No.: PCT/IB2023/059687

§ 371 Date: Mar. 28, 2025

(30) Foreign Application Priority Data
Sep. 29, 2022 (BE) BE2022/5781

(51) Int. Cl. E04F 10/08; F16J 15/02; F16M 13/02

(52) U.S. Cl. CPC E04F 10/08; F16J 15/025; F16M 13/022; F16M 2200/028

(57) ABSTRACT

The disclosure provides a terrace canopy comprising at least one structural element being a beam or a column. The structural element comprises a cavity which is open on the outside of the structural element and configured for holding a power cable for supplying power to a functional component attachable to the structural element. The terrace canopy further comprises a seal for sealing the open side of the cavity, wherein said seal is elastically deformable between an open state and a sealing state, wherein the seal is able to simultaneously assume different of said states at different locations of the seal in said longitudinal direction.

### TECHNICAL FIELD

The present invention relates to a terrace canopy.

### STATE OF THE ART

Terrace canopies are usually arranged to screen off or, on the contrary, to clear an outdoor area. Such terrace canopies are often arranged near houses, restaurants, shops, etc. to screen off an outdoor terrace or the like from sunlight, precipitation and/or wind, or on the contrary, to temporarily allow in sunlight. These terrace canopies can be implemented, for example, in the form of an awning, a pergola, a veranda, a carport, a pavilion, etc.

Such a terrace canopy typically comprises a roof frame that is at least partially supported by columns. Exceptionally, the roof frame may also be supported by another roof construction. The roof frame is generally constructed of several beams (i.e. structural elements) that are composed into one or more frames into which a roof infill can be attached. The beams themselves are often a composition of a plurality of individual profiles. Such a roof arrangement is typically supported by four (or more) columns (i.e. structural elements) between which a wall infill may be provided. Likewise, less columns may be used in case the roof frame is supported by other structures, such as a wall of an already existing structure.

The roof infill can be stationary or movable, for example a sliding roof. The roof infill of a sliding roof can, for example, consist of a roll-up fabric or screen, slats that rotate around their axis, or segments that can slide over each other. The segments can be panels that are partly made of (laminated) glass or plastic, such as PC or PMMA. Depending on the choice of material, the light transmission and robustness of the roof can be tailored to the desired application. The wall infill can also be stationary or movable. Examples are a roll-up cloth or screen or movable, i.e. slidable or foldable panels.

In addition, different types of columns have already been developed that, in addition to their general support function, include other functions. The columns can be adapted to also provide supply lines to electrical equipment and/or to include drain pipes for the removal of precipitation and/or to include guiding profiles for a screen. Preferably, the column should be able to comprise all the functions described above and also be finished as aesthetically as possible from the outside.

WO 2021/214677 A1 discloses a terrace canopy, constructed from a number of structural components, i.e. columns and beams, each extending in a longitudinal direction (typically horizontal for beams and vertical for columns). In certain embodiments, disclosed in WO 2021/214677 A1, beams are provided on their underside with one or more open cavities that allow to integrate wall infill into the beam. In certain embodiments, disclosed in WO 2021/214677A 1 , columns are provided on their side with one or more open cavities that allow to integrate wall infill into the column.

It is also known from WO 2021/214677 A1 to provide lighting on the outside of the terrace canopy by placing LED strips in a cavity in the beam. It is also known to provide lighting in the form of LED strips on the inside of the terrace canopy as disclosed in DE 10 2016 117 774 A1, where LED strips are attached to the beams.

There is also a general need for the integration of functional components in a terrace canopy. An example of such an integration is disclosed in WO 2021/048773 A1 where a slat is disclosed with an integrated heating element therein. It is also known to provide lighting, e.g. in the form of LED strips, in or on the beams of a terrace canopy.

A general problem with the integration of functional components is that it is often not possible (or at least very difficult) to add them later to a terrace canopy, or to remove or replace them later. A major obstacle is the need for a power supply, which is typically not quick and easy to install in an existing terrace canopy. In other words, although functional components are available for terrace canopies, the terrace canopies do not allow for flexible adjustment to the needs and wishes of users.

In other technical fields, it is known to provide a profile housing in which, on opposite sides, in each case an open wire (e.g. copper) is present. The one wire is the positive side and the other wire is the negative side. A functional component is thus supplied with power through contact with both wires. However, this solution is not applicable in the context of terrace canopies for use in the outdoor environment due to the influences of precipitation, dirt, insects, etc., which can negatively affect the operation of the open wires.

Another well-known solution is to shield the open wires with silicone and to make electrical contact by locally breaking the silicone with connection pins. However, this does not allow to remove or move the functional component later because part of the power wires will then be exposed to the outside environment.

### DESCRIPTION OF THE INVENTION

It is an object of the present invention to provide a terrace canopy that at least partially solves the drawbacks described above.

This object is achieved by said cavity being configured to hold at least one power cable for supplying power to one or more functional components attachable to said structural element, and the terrace canopy further comprising a seal for sealing the open side of said cavity, wherein said seal extends in said longitudinal direction and is elastically deformable between an open state and a sealing state, wherein the seal is able to simultaneously assume different of said states at different locations of the seal in said longitudinal direction.

By arranging said cavity for receiving and holding a power cable, at least the power supply for the functional components is present or can be easily arranged. This is because the cavity is open on the outside of the structural element through which the power cable can be inserted. The seal also serves to protect the inside of the cavity from the natural elements, such as precipitation, dirt, dust, insects, etc. In other words, the power cable, if present, is not directly exposed to the natural elements. It also hides the power cable from the view of users such that it can therefore be perceived as less visually disturbing.

In addition, the seal can be open or closed at different locations at the same time and is deformable between these states. In other words, the seal can first be used flexibly to seal a specific location or not at all (e.g. if at a later date there is or is no longer a need for a functional component). Furthermore, the seal also allows an opening to be provided at one or more locations along the structural element, such that several functional elements can be fitted simultaneously, while the unused part of the open side (i.e. where no functional element has been fitted) is still sealed.

In an embodiment of the present invention, the seal comprises a rigid portion and an elastic portion, wherein the rigid portion is attached to said structural element and wherein the elastic portion, in the sealing state, seals the open side. As will be seen below, the provision of a rigid portion is advantageous because it can simply serve to attach the seal to the structural element without the need for additional separate fasteners, such as screws, bolts, glue, etc.

In an embodiment of the present invention, the seal comprises only an elastic portion. This makes sealing easier. Typically, but not always, there will be a need for additional separate fasteners, such as screws, bolts, glue, etc., to attach the elastic seal to the structural member.

In an embodiment of the present invention, said structural element comprises holder means, wherein the seal, in particular the rigid portion thereof, is held on said structural element, in particular in said cavity, by means of the holder means, wherein said holder means preferably comprise two hooks facing each other projecting from a wall delimiting said cavity, wherein a portion of the seal, in particular the rigid portion, is held between said hooks and a part of said wall.

Providing holder means in said structural element, in particular in the cavity therein, provides an elegant way of attaching the seal without the need for additional separate fastening means. It allows a part (such as the rigid portion, if present) to be fixedly placed in the holder means. Hooks are advantageous because they can be manufactured integrally together with the rest (or a portion) of the structural element, e.g. via extrusion. In addition, the seal can then be inserted into the cavity in the longitudinal direction of the structural element, with a portion already in the holder means.

In addition, the holder means may also have a shape into which a thicker (but not necessarily rigid) portion of the seal fits. For example, the holder means can be C-shaped, wherein the seal, in particular the fully elastic seal, has a thickening on one edge that fits therein.

In an embodiment of the present invention, the seal comprises two substantially L-shaped elements located opposite each other, wherein each L-shaped element comprises a first leg and a second leg, wherein the first leg is attached to said structural element and wherein the second legs, in the sealing state, together seal the open side. Preferably, each first leg forms the rigid portion of the seal. Preferably, the second leg pivots relative to the first leg when the seal moves between its states. Preferably, each L-shaped element is provided with a strut, wherein said strut preferably extends between the free (i.e. distal) ends of the first and the second leg.

The use of two separate elements to form the seal has a number of advantages. First of all, each element, in particular each second leg, can have a dimension, namely a width, which is smaller than the width of the open side. As a result, also a height dimension of the cavity can be limited in case the second leg pivots relative to the first leg when the seal moves between its states. Namely, in such an embodiment, the height dimension of the cavity should be at least as high as the width dimension of the second leg.

In addition, the second leg of each element in the sealing state can also be directed inwards towards said cavity. This is impossible in an embodiment where only one leg has to cover the entire open side. Such inwards directed legs can serve as a supporting surface for the power cable, in which case a strut is advantageous to increase the carrying capacity of the first legs. The struts can also be used to shield the space between the legs (i.e. by extending the strut between the free ends of the legs), e.g. to prevent a power cable from being caught between them. The fact that the second legs are already directed towards the inside of the cavity, also allows them to be bent deeper with minimal force in order to gain access to the cavity. In other words, the power cable(s) can be placed as quickly as possible.

In an embodiment of the present invention, the seal or each of the substantially L-shaped elements is integrally manufactured from an elastomer, such as rubber, for example via an extrusion process, such as co-extrusion, which can be used to integrally manufacture a seal having a rigid portion and an elastic portion.

In an embodiment of the present invention, said structural element is a beam, wherein the open side is located at an underside of the beam, and wherein the seal, in its sealing state, is configured to support said at least one power cable. In this way, no separate holder means are required for holding the power cable(s) in the cavity against the effect of gravity.

In an embodiment of the present invention, the terrace canopy further comprises a mounting element which is slidably disposed in said cavity, wherein said mounting element is configured for attaching thereto a functional component of said one or more functional components, wherein the mounting element is connectable to said at least one power cable. The use of a sliding mounting element further increases the functionality of the functional component(s) because it can be moved along the structural element. The slidable mounting element can further serve as a type of universal mounting onto which different types of components can be mounted, which increases the ease of use for an end user.

In an embodiment of the present invention, the mounting element comprises two opposed side walls connected by means of an intermediate part, wherein each side wall extends in said longitudinal direction and is rotatable relative to the intermediate part along an axis extending in said longitudinal direction for positioning the mounting element in said cavity through the open side. The tilting side walls still allow the mounting element, which is wider than the width of the opening that provides access into the cavity, to be placed through this opening. In other words, the mounting element can be inserted into the cavity through the open side, such that a lateral insertion (i.e. through a face end of the cavity) is unnecessary, wherein said lateral insertion is not (easily) possible with an already mounted terrace canopy.

In an embodiment of the present invention, said structural element comprises guiding means for holding and guiding the mounting element. This helps to prevent the mounting element from becoming accidentally detached from the cavity. In addition, this ensures a smoother movement of the mounting element as well as lowering the risk of a blockage.

In an embodiment of the present invention, the guiding means comprises a first pair of opposed lips and a second pair of opposed lips, the one lip of a pair extends from a first wall delimiting said cavity and the other lip of a pair extends from a second wall delimiting said cavity, wherein the one lips of both pairs face each other and the other lips of both pairs face each other. In particular, the lips are formed by the same element which forms the hooks for fixing the seal. This results in a compact design since one element performs a double function.

In an embodiment of the present invention, the mounting element comprises two opposing side walls connected by means of an intermediate part, wherein the side walls come into contact with a corresponding one of the lips. In this way, the edges of each side wall are in contact with a lip for holding, aligning and guiding the mounting element with a minimum number of components.

In an embodiment of the present invention, the mounting element comprises blocking means which are movable between an open state in which the mounting element is slidable through said cavity in said longitudinal direction and a blocking state in which the mounting element is not slidable through said cavity. These locking means prevent the mounting element (or the functional component attached to it) from shifting accidentally, e.g. due to wind influences.

In an embodiment of the present invention, the blocking means comprise a movable wall which, in the blocking state, clamps part of the mounting element against said structural element. The use of a clamping effect ensures a blocking without causing damage to the terrace canopy (as opposed to the use of nails or the like), such that repeatedly opening and blocking the mounting element does not have any adverse effects. It is also user-friendly as only minimal effort is required to block or unblock the mounting element.

In an embodiment of the present invention, the blocking means comprise one or more separate elements, such as bolts or screws. Such separate elements are then mainly intended for functional components that need not be moved. The advantage is an increased security against theft. The individual elements are preferably not visible from the outside of the terrace canopy, for example by hiding them from view via the seal.

In an embodiment of the present invention, the mounting element has a first side facing said open side and a second side opposite said first side, wherein the second side is provided with an elongated groove for positioning said at least one power cable. Such a groove contributes to preventing a power cable from becoming wedged between the mounting element and the structural element.

In an embodiment of the present invention, the terrace canopy further comprises one or more of said one or more functional components, wherein said one or more functional components preferably comprise one or more of: a lighting element, such as a spotlight or an LED; an audio element, such as a loudspeaker; an imaging element, such as a projector; a heating element, such as an electric heater; a sensor, such as a rain sensor, wind sensor, or a light sensor; a ventilation element, such as a fan; a power supply, such as a wall outlet or USB port; or a holder to which an element, such as a screen or decoration, can be attached. This increases the available options that an end user can apply in his terrace canopy.

In an embodiment of the present invention, the terrace canopy further comprises said at least one power cable, disposed in said cavity. In other words, the power cable has already been pre-installed, such that an end user needs less time to install functional components. In time, the power cable can also serve for communication and/or control of one or more connected functional components, i.e. the term “power cable” is intended to also comprise the term “data cable”.

### BRIEF DESCRIPTION OF THE DRAWINGS

The invention will hereinafter be explained in further detail with reference to the following description and the accompanying drawings.

FIG. 1 shows an embodiment of a terrace canopy according to the present invention.

FIG. 2 shows a side view of a portion of a structural element of a terrace canopy according to the present invention.

FIG. 3 shows a perspective view of a portion of the seal used in a terrace canopy according to the present invention.

FIGS. 4A and 4B show a perspective view of a sliding mounting element used in a terrace canopy according to the present invention in the free and blocking states, respectively.

FIGS. 5A through 5E show successive steps in placing a sliding mounting element in a terrace canopy according to the present invention.

FIG. 6 shows a schematic representation of the power supply used in a terrace canopy according to the present invention.

FIG. 7 shows a section through a power cable used in a terrace canopy according to the present invention.

FIG. 8 shows the same view as FIG. 2 for another embodiment of the seal.

### EMBODIMENTS OF THE INVENTION

The present invention will be described below with reference to specific embodiments and with reference to specific drawings, but the invention is not limited thereto and is defined only by the claims. The drawings shown here are only schematic representations and are not limitative. In the drawings, the dimensions of certain components may be enlarged, which means that the components in question are not shown to scale, and this is for illustrative purposes only. The dimensions and relative dimensions do not necessarily correspond to the actual practice of the invention.

In addition, terms such as “first”, “second”, “third”, and the like are used in the description and in the claims to distinguish between similar elements and not necessarily to indicate a sequential or chronological order. The terms in question are interchangeable in appropriate circumstances, and the embodiments of the invention may operate in different orders than those described or illustrated herein.

In addition, terms such as “top”, “bottom”, “above”, “below”, and the like are used in the description and in the claims for descriptive purposes. The terms thus used are interchangeable in appropriate circumstances, and the embodiments of the invention may operate in orientations other than those described or illustrated herein.

The term “comprising” and derivative terms, as used in the claims, should and should not be construed as being limited to the means set forth in each case thereafter; the term does not exclude other elements or steps. The term should be interpreted as specifying the listed properties, integers, steps, or components referred to, without, however, excluding the presence or addition of one or more additional properties, integers, steps, or components, or groups thereof. The scope of an expression such as “a device comprising means A and B” is therefore not limited only to devices consisting solely of components A and B. Rather, what is meant is that, with regard to the present invention, the only relevant components are A and B.

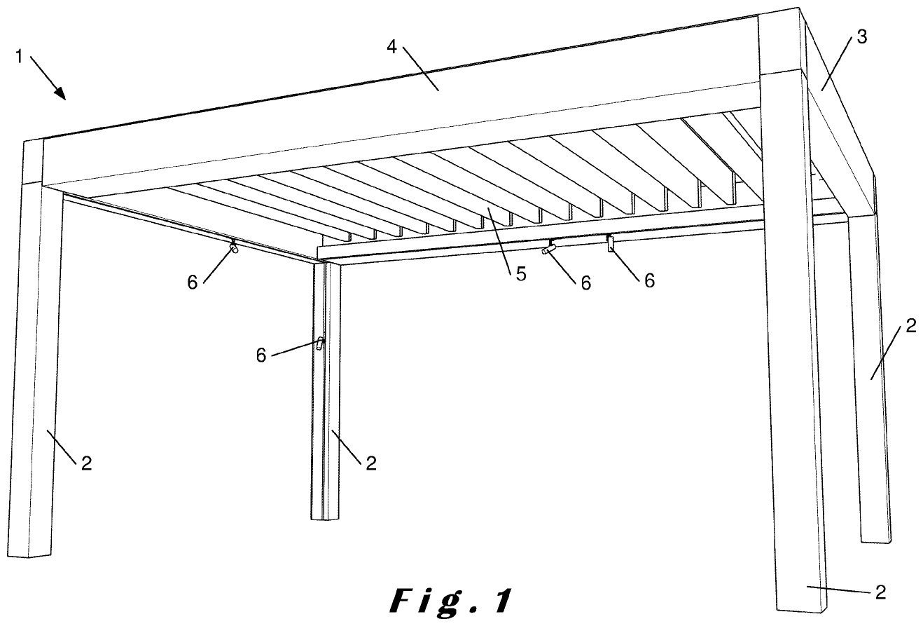

With regard to FIG. 1, any reference to an orientation of the beams will be interpreted with reference to the position when mounted in the terrace canopy. In this way, there are four orientations, namely above, below, outside and inside. In this case, “above” refers to the portion of the beam that is or will be oriented towards the upper plane (the sky, e.g. the open sky), “below” refers to the portion of the beam that is or will be oriented towards the ground plane (the earth, e.g. the decking), “outside” to the portion of the beam that is or will be oriented away from the roof, i.e. away from the roof infill and “inside” to the portion of the beam that is or will be oriented to the inside of the roof, i.e. directed towards the roof infill. The term “substantially” comprises variations of +/−10% or less, preferably +/−5% or less, more preferably +/−1% or less, and more preferably +/−0.1% or less, of the specified state, as far as the variations are applicable to function in the disclosed invention. It is to be understood that the term “substantially A” is intended to also comprise“A”.

FIG. 1 illustrates a terrace canopy 1 for a ground surface, for example a terrace or garden. The terrace canopy comprises a plurality of columns 2 which support different beams 3, 4. The columns and beams together form frames to which wall infills (not shown) and/or roof coverings 5 can be attached, as described below. The terrace canopy 1 comprises two types of beams 3, 4, namely:
a beam 3 that serves as an external pivot beam 3 on the outside of the terrace canopy 1; and
a beam 4 serving as tension beam 4.

In other embodiments, a third type of beam is also present in a terrace canopy, namely a beam that serves as a central pivot beam in the centre of the terrace canopy 1. It will also be appreciated that the beams 3, 4 can be attached to other structures, for example a wall or facade, instead of solely supporting on columns 2, as shown in FIG. 1. In such a way, the terrace canopy 1 can generally be used for shielding an outdoor space, as well as for an indoor space. Hereafter, the term “structural element” will be used to indicate both the beams 3, 4 and the columns 2 of the terrace canopy 1.

In the embodiment shown, the roof covering 5 is formed by slats which are rotatably attached at their face ends to pivot beams 3. The slats are rotatable between an open state and a closed state. In the open state, there is an intermediate space between the slats through which, for example, air can be introduced into or leave the underlying space. In the closed state, the slats form a closed canopy with which the underlying space can be shielded from wind and/or precipitation, such as rain, hail or snow. For the discharge of precipitation, the slats are typically arranged with a sloping angle towards one of the two pivot beams 3.

The slats are typically made of a rigid material. This could be aluminium, for example. Aluminium has many advantages as a material, as it is robust and light at the same time, resistant to bad weather conditions and requires little maintenance. However, other materials are also suitable and their advantages or disadvantages are assumed to be known to those skilled in the art. A slat can be produced using different techniques, depending on the material, including extrusion, milling, setting, casting, welding, and so on. The appropriate manufacturing technique is assumed to be known by those skilled in the art. Preferably, the slats are manufactured by means of an extrusion process. Optionally, filling elements made of, for example, polycarbonate, glass, wood, etc. can be used to at least partially fill the hollow slats, for example to obtain a different appearance of the slat.

In an embodiment, the slats can also be slidably provided, in their open state, in the terrace canopy 1, in order to further increase the control options in terms of light, radiant heat and ventilation.

More generally, the roof covering 5 is stationary or movable. A movable roof covering comprises, for example, tiltable and/or slidable slats (as described above) and/or screens that can be rolled up and down and/or slidable panels. In their closed state, the individual elements of the movable roof covering 5 form a substantially watertight roof with which the underlying space can be shielded against, for example, wind and/or precipitation, such as rain, hail or snow. This roof covering 5 is typically drained to the pivot beams 3 and from there, directly or via the tension beams 4, to the columns 2. By sliding and/or rotating the slats and/or the panels and/or by rolling up a screen, the roof covering 7 can at least be partially opened and/or closed in order to be able to determine the incidence of light, radiant heat, ventilation, precipitation, etc. to the space under the roof covering 5, as desired.

Wall infills (not shown) are typically intended to screen off openings under the terrace canopy 1 between the columns 2. The wall infills can be stationary or movable. Movable side walls comprise, for example, roll-up and roll-down screens and/or wall elements that are slidably arranged relative to each other, etc. Stationary side walls can be made from different materials, such as plastic, glass, metal, textile, wood, etc. Combinations of different wall infills are also possible.

FIG. 1 further illustrates that the terrace canopy 1 is further provided with a number of lighting elements 6 that are attached to the structural elements 2, 3, 4. Although the terrace canopy 1 is shown with lighting elements 6, it should be clear that other functional components are also possible such as: a lighting element, such as a spotlight or an LED; an audio element, such as a loudspeaker; an imaging element, such as a projector; a heating element, such as an electric heater; a sensor, such as a rain sensor, wind sensor, or a light sensor; a ventilation element, such as a fan; a power supply, such as a wall outlet or USB port; or a holder to which an element, such as a screen or decoration, can be attached. Details about these functional components 6 and how they are connected to the terrace canopy 1 will be described further.

In general, the structural elements 2, 3, 4 are composed of one or more profiles as described in WO 2021/214677 A1. The profiles are typically made of a rigid material. This can be aluminium, for example. Aluminium has many advantages as a profile material, as it is robust and light at the same time, resistant to bad weather conditions and requires little maintenance. However, other materials are also suitable and their advantages or disadvantages are assumed to be known to those skilled in the art. A profile can be produced using various techniques depending on the material, including extrusion, milling, bending, casting, welding, etc., with extrusion being preferred. The appropriate manufacturing technique is presumed to be known by those skilled in the art.

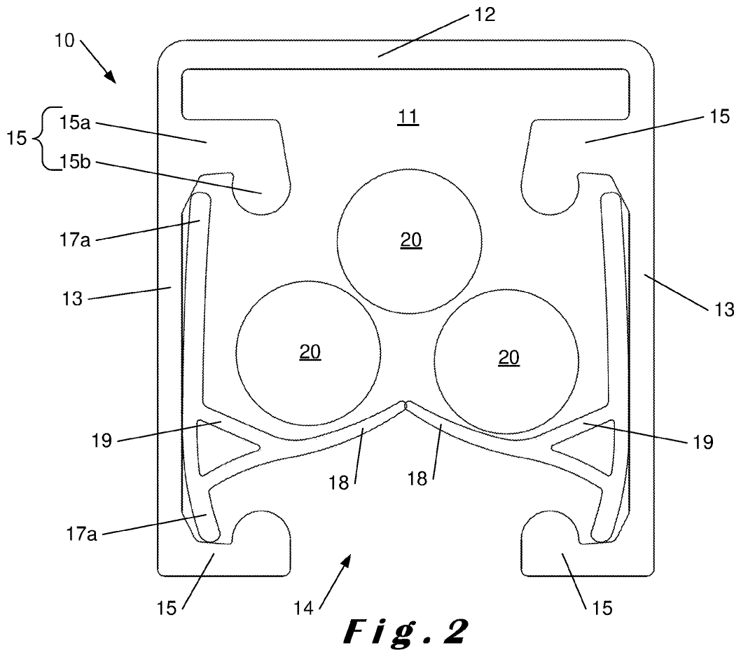

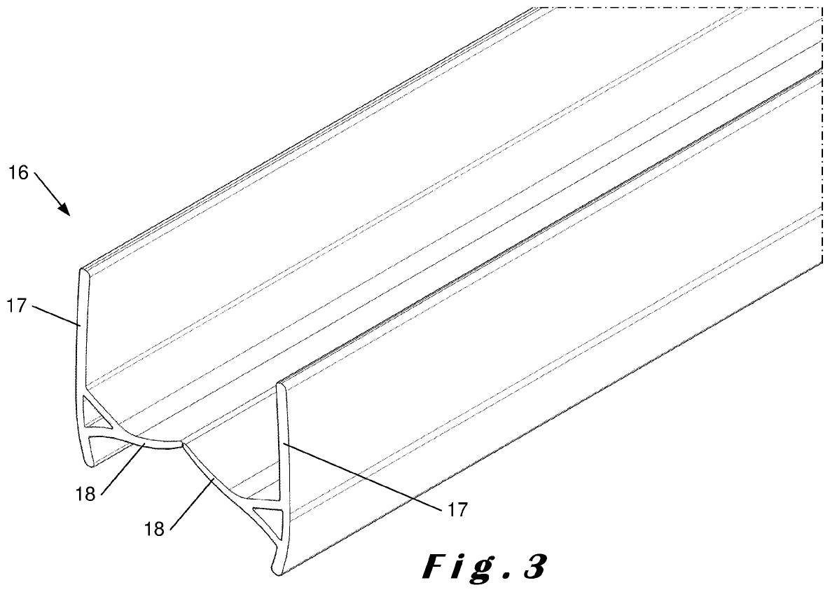

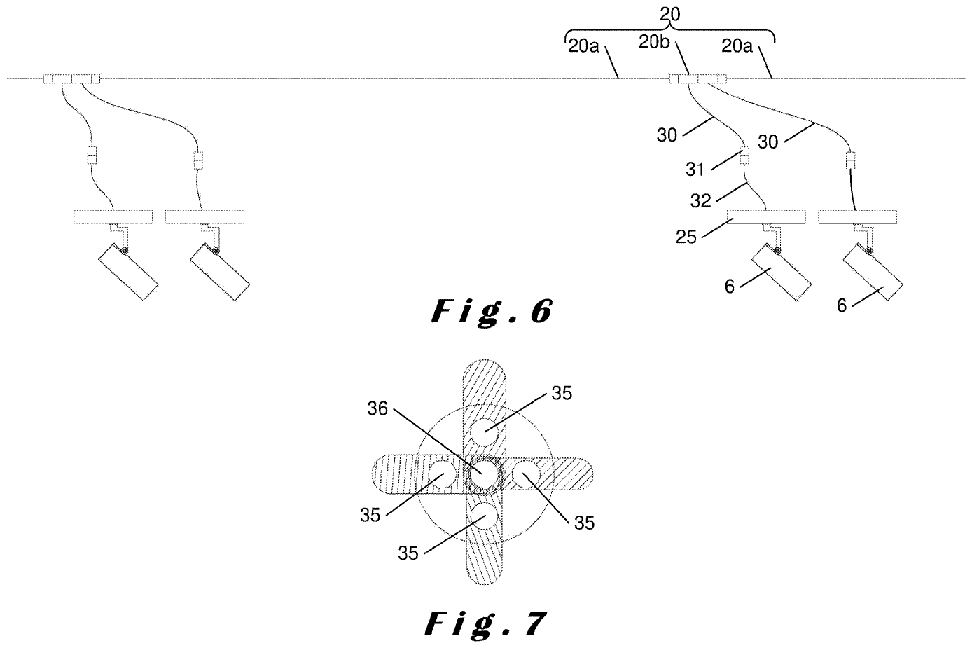

One of the profiles present in the structural elements 2, 3, 4 is a holder profile 10, shown in side view in FIG. 2. The holder profile 10 is generally hollow and is provided with an open side 14 that is located on the outside of a structural element 2, 3, 4. The holder profile 10 is therefore provided with a cavity 11 which is surrounded by a rear wall 12 and two side walls 13, wherein the open side 14 is located between the two side walls 13. Two protrusions 15 extend from each side wall 13, comprising a thin portion 15a and a thick portion 15b. The function of these protrusions 15 is described below. The holder profile 10 forms part of the structural elements 2, 3, 4 and can be integrated therewith in various ways, as is known to the skilled person from the terrace canopy, disclosed in WO 2021/214677 A1. In an embodiment, the holder profile 10 can be formed as part of a beam, for example in wall holder profile 21 in FIG. 3D of WO 2021/214677 A1 ; wall holder profile 21 a in FIG. 3E of WO 2021/214677 A1 ; wall holder profile 21 b in FIG. 3F of WO 2021/214677 A1. In an embodiment, the holder profile 10 can be formed as part of a column 2, for example in wall guiding profile 86 in FIG. 7E or 7F of WO 2021/214677 A1.

For sealing the open side 14, a seal 16 is provided, which is shown separately in FIG. 3. In the embodiment shown, the seal 16 comprises two separate identical L-shaped elements, each of which is integrally manufactured from an elastomer, such as rubber. Each L-shaped element comprises a first leg 17 and a second leg 18. The first leg 17 is rigid, compared to the elastic second leg 18. In the embodiment shown, this is done by making the first leg 17 thicker than the second leg 18. As shown in FIG. 2, the ends 17a of the first leg 17 hook behind the thick part 15b of the protrusions 15. In this way, the rigid portion 17 is fixedly held in the holder profile 10. The first legs 18 together close off the open side 14 of the holder profile 10. The first legs 18 are directed towards the inside of the cavity 11 in their rest state (shown in FIG. 2), which is advantageous if the holder profile 10 is located on the underside of a beam 3, 4. The seal 16 is preferably already placed in the holder profile 10 during the production process, but can also be placed at a later point in time, such as when the terrace canopy 1 is being constructed or even when the terrace canopy 1 has already been constructed. Furthermore, the seal 16 comprises a supporting leg 19 which forms an additional connection between the legs 17, 18 and contributes to keeping the first legs 18 in their rest state. In particular, the supporting legs 19 prevent the first legs 18 from bending further towards the open side 14 as a result of load. The supporting legs 19 actually form a strut of the L-shaped elements.

In the embodiment shown, three power cables 20 are further placed in the holder profile 10, although, of course, more or less cables are possible. The seal 16 shields these cables 20 from external conditions and can also support them if holder profile 10 is located on the underside of a beam 3, 4. The power cables 20 can be placed during the construction of the terrace canopy 1. However, they will typically only be installed after the terrace canopy 1 has been constructed by pushing the cables 20 through the open side 14. This is easily possible in terrace canopies 1 where (as shown in FIG. 1) a holder profile 10 is present in at least one column 2 and the beams 3, 4 connected to it. It is also possible to place power cables internally through column 2, i.e. without using a holder profile, to provide power cables 20 in the holder profile 10 in the beams 3, 4.

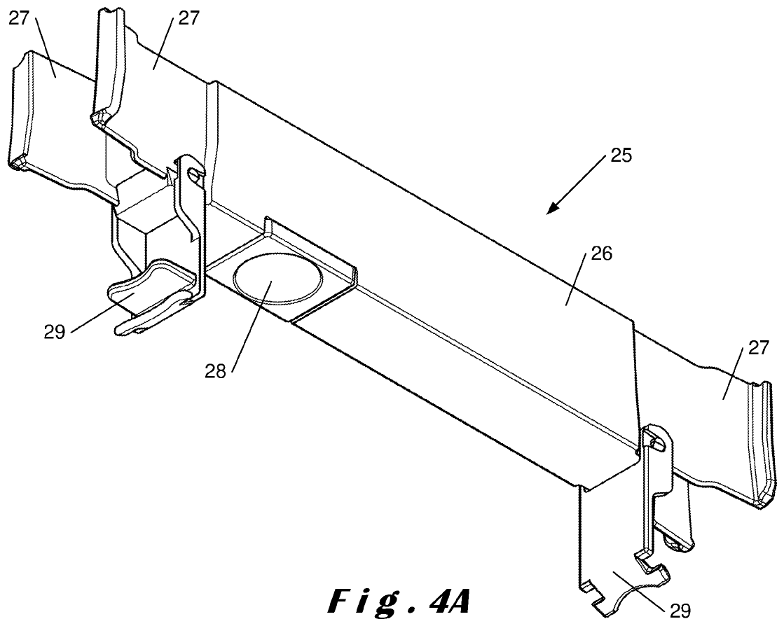

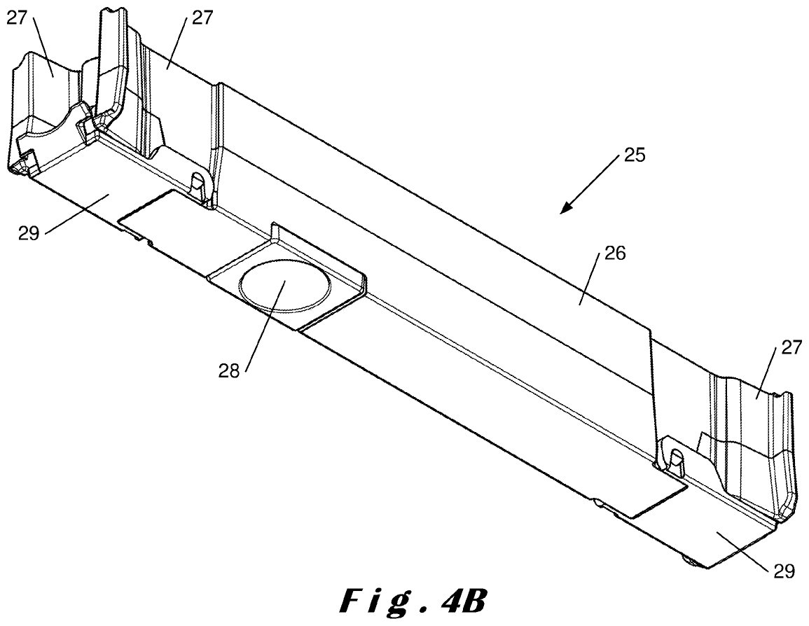

FIGS. 4A through 5E show details about a mounting element 25 for mounting functional components 6 thereon. The mounting element 25 is generally beam-shaped and comprises a central tube 26 on which side walls 27 are provided at both ends. The tube 26 is rigid and has a width that is smaller than the open side 14, such that the tube 26 can be inserted into the cavity 11 via the open side 14. This allows the mounting element to be placed in an existing terrace canopy 1. The tube 26 is further provided with a connection 28 to which the functional element 6 can be mounted. The mounting element further has two pivotable lips 29 that can be rotated between an open state (FIG. 4A) and a blocking state (FIG. 4B). In the blocking state, the lip 29 pushes the side walls 27 away from each other.

The various side walls 27 are rotatable relative to the tube 26 about the longitudinal direction of the tube 26. This is best shown in FIGS. 5A through 5E. In the rest state (FIG. 5A) of the mounting element, the side walls 27 are mutually parallel and in line with the tube 26. When the tube 26 is pushed into the holder profile 10 (FIG. 5B), the side walls 27 tilt into a first orientation, such that the top sides of the side walls 27 approach each other and thus fit into the open side 14. When the holder profile 10 is pushed in deeper (FIG. 5C), the side walls 27 tilt into a second orientation, opposite to the first orientation, such that the top sides of the side walls 27 move away from each other such that the undersides of the side walls 27 also fit in the open side 14. When pushed in even further (FIG. 5D), the side walls 27 return to their rest state. FIG. 5D illustrates that the edges of the side walls 27 come into contact with the thick portion 15B of the protrusions 15 which serve as guides therefrom. In this situation, the mounting element 25 can be moved along the holder profile 10 until it has reached the desired location. FIG. 5E then illustrates the step of blocking the mounting element 25 by rotating the lips 29 such that the side walls 27, in particular the lower edges thereof, are clamped against the thick part 15B of the protrusions 15, such that a displacement of the mounting element 25 along the cavity 11 is no longer possible. By turning away the lips 29 again, the mounting element 25 can slide back along the holder profile 10 such that the placement of a functional element 6 can be easily varied both along the beam 3, 4 or along a column 2.

By placing the mounting element 25 in the cavity 11, the seal 16 is locally (i.e. at the location of the mounting element) deformed. More specifically, the second legs 18 are pushed inwards towards the side walls 13 of the holder profile 10. In this way, the seal 16 is locally moved from its sealing state to its open state. Locally, the mounting element 25 then provides sealing of the open side 14. At other locations (except immediately adjacent to the mounting element, as there is typically a transition in the longitudinal direction between the sealing state and the open state) along the holder profile 10, the seal 16 is still in its sealing state with the second legs 18 in contact with each other.

FIGS. 5A through 5E also illustrate that the mounting element 25, in particular the tube 26, is provided with an elongated groove 34 on its side facing the cavity for positioning the power cable 20 in the holder profile 10.

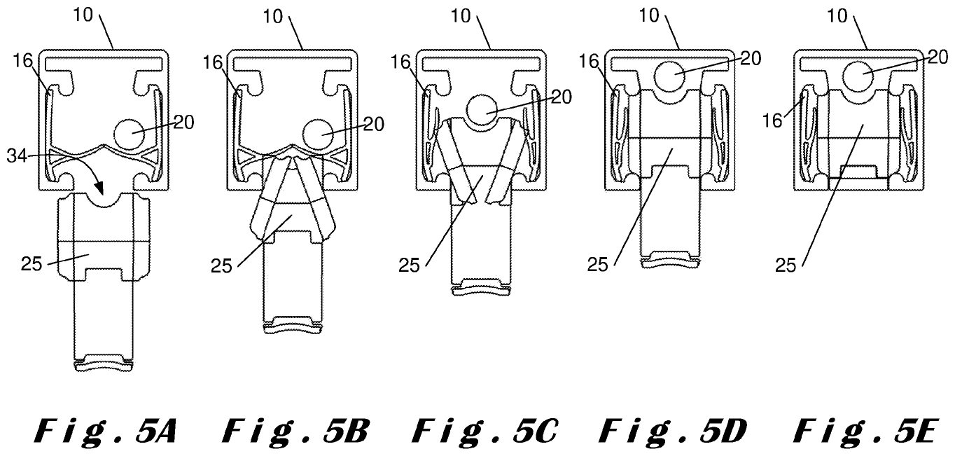

FIG. 6 shows a schematic representation of the power supply, used in the terrace canopy 1. The power cable 20 is composed of several identical segments 20a connected to a connector 20b which also allows one or more branches 30. An end adapter 31 is provided per branch, to which a power cable 32 is coupled which runs to the mounting element 25 on which the functional component 6 is placed. This modular system allows the power cable 20 to be made as long as necessary and also allows different functional components 6 to be connected simultaneously.

FIG. 7 shows a section through a power cable 20 passing through the cavity 11. The cable 20 is provided with four separate feeds 35 (e.g., a positive wire) and one common return (e.g., a negative wire). This allows four functional components 6 (or more than four functional components 6 but divided into a maximum of four groups) to be controlled separately with one power cable 20.

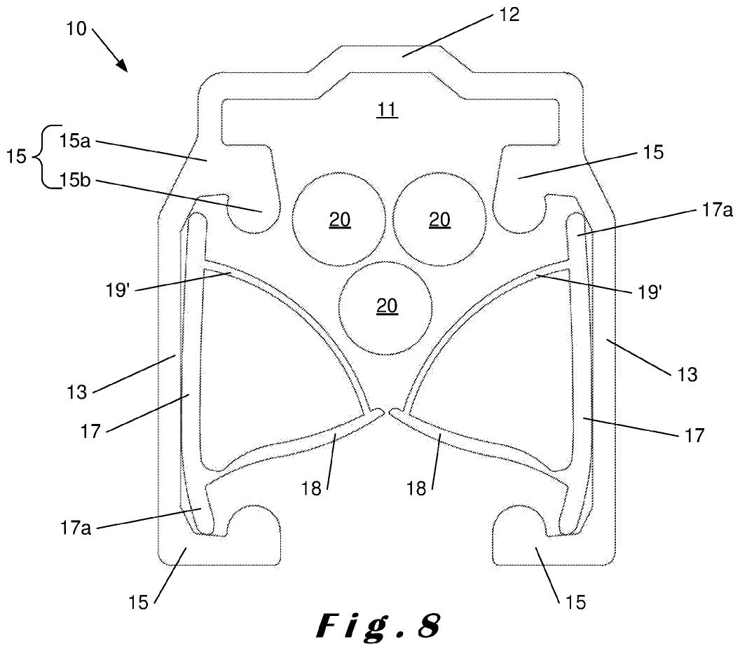

FIG. 8 shows an alternative embodiment of the present invention. Identical elements are indicated by the same reference numerals as in the previous figures. The main difference with the embodiment shown in FIG. 2 is the shape of the struts 19′. The struts 19′ now connect the distal ends of the legs 17, 18 with each other, in other words, the struts 19′ extend between the free ends of the legs 17, 18. The advantage of such an arrangement is to avoid that one or several of the power cables, when moving to the open state of the first legs 18, touches the space between the first and second legs. The curvature of the struts 19′ contributes to this because this curvature gives rise to outward folding (i.e. away from the angle/space formed between the legs 17, 18) of the struts 19′ when moving the first leg 18 to its open state.

It should be clear that other forms of sealing 16 are also possible for sealing the open side 14 of the holder profile 10. In an embodiment, only one element is present that covers the entire open side 14, for example an elastomer strip that is fixed on one side to the holder profile 10 (by way of illustration via gluing or via a suitable holder and a thickening on the strip). In an embodiment, the seal 16 is not made of elastomer, but it may, for example, take the form of a brush seal. Furthermore, rigid plate-shaped elements can also be used that are hingedly attached to the holder profile 10. The seal 16 shown also need not be manufactured in one piece over the entire length of the structural element 2, 3, 4. For example, use can be made of separate strips with a fixed length, e.g. 1 meter.

It should further be clear that the holder profile 10 need not be a separate profile, but can be integrated into and form part of other profiles that are part of the structural element. Moreover, the holder profile 10 can also be formed by an assembly of several separate profiles.

While certain aspects of the present invention have been described with respect to specific embodiments, it is to be understood that these aspects may be implemented in other forms within the scope of protection as defined by the claims.

1. A terrace canopy comprising at least one structural element being a beam or a column, wherein said structural element extends in a longitudinal direction and has an outer side, wherein a cavity[[(11)]] is provided in said structural element which is open on the outer side of the structural element, wherein said cavity extends in said longitudinal direction,
wherein the cavity is configured for holding at least one power cable for supplying power to one or more functional components attachable to said structural element, and
wherein the terrace canopy further comprises a seal for sealing the open side of said cavity, wherein said seal extends in said longitudinal direction and is elastically deformable between an open state and a sealing state, wherein the seal is capable of simultaneously assuming different ones of said states at different locations of the seal in said longitudinal direction.

2. The terrace canopy according to claim 1, wherein the seal comprises a rigid portion and an elastic portion, wherein the rigid portion is attached to said structural element and wherein the elastic portion, in the sealing state, closes off the open side.

3. The terrace canopy according to claim 1, wherein the structural element comprises holder means, wherein the seal is held on said structural element, in particular in said cavity, by means of the holder means,
wherein said holder means preferably comprise two hooks which face each other and project from a wall delimiting said cavity, wherein a portion of the seal is held between said hooks and a part of said wall.

4. The terrace canopy according to claim 1, wherein the seal comprises two substantially L-shaped elements which are located opposite each other, wherein each L-shaped element comprises a first leg and a second leg, wherein the first leg is attached to said structural element and wherein the second legs, in the sealing state, together seal the open side, wherein each L-shaped leg preferably comprises a strut.

5. The terrace canopy according to claim 1, wherein the seal is integrally manufactured from an elastomer.

6. The terrace canopy according to claim 1, wherein the structural element is a beam, wherein the open side is located at an underside of the beam and wherein the seal, in its sealing state, is configured to carry said at least one power cable.

7. The terrace canopy according to claim 1, wherein the terrace canopy further comprises a mounting element slidably mounted in said cavity, wherein said mounting element is configured for attaching thereto a functional component of said one or more functional components, wherein the mounting element is connectable to said at least one power cable.

8. The terrace canopy according to claim 7, wherein the mounting element comprises two opposite side walls connected by means of an intermediate part, wherein each side wall extends in said longitudinal direction and is rotatable with respect to the intermediate part along an axis extending in said longitudinal direction for positioning the mounting element in said cavity through the open side.

9. The terrace canopy according to claim 7, wherein the structural element comprises guiding means for holding and guiding the mounting element.

10. The terrace canopy according to claim 9, wherein the guiding means comprises a first pair of opposed lips and a second pair of opposed lips, wherein the one lip of a pair extends from a first wall delimiting said cavity and the other lip of a pair extends from a second wall delimiting said cavity, wherein the one lips of both pairs face each other and the other lips of both pairs face each other,
wherein the mounting element preferably comprise two opposing side walls connected by means of an intermediate part, wherein the side walls come into contact with a corresponding one of the lips.

11. The terrace canopy according to claim 7, wherein the mounting element comprises blocking means that are movable between an open state in which the mounting element is slidable through said cavity in said longitudinal direction and a blocking state in which the mounting element is not slidable through said cavity.

12. The terrace canopy according to claim 11, wherein the blocking means comprise a movable wall which, in the blocking state, clamps part of the mounting element against said structural element.

13. The terrace canopy according to claim 7, wherein the mounting element has a first side facing said open side and a second side opposite said first side, wherein the second side is provided with an elongated groove for positioning said at least one power cable.

14. The terrace canopy according to claim 1, wherein the terrace canopy further comprises one or more of said one or more functional components, wherein said one or more functional components preferably comprise one or more of: a lighting element, such as a spotlight or an LED; an audio element, such as a loudspeaker; an imaging element, such as a projector; a heating element, such as an electric heater; a sensor, such as a rain sensor, wind sensor, or a light sensor; a ventilation element, such as a fan; a power supply, such as a wall outlet or USB port; or a holder to which an element, such as a screen or decoration, can be attached.

15. The terrace canopy according to claim 1, wherein the terrace canopy further comprises said at least one power cable arranged in said cavity.
